(19) United States
(12) Patent Application Publication
(10) Pub. No.: US 2009/0267260 A1
(43) Pub. Date: Oct. 29, 2009

(54) METHOD OF PRODUCING POLYMER FILM

(75) Inventor: Naoki Nakamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/088,244

(22) PCT Filed: Sep. 26, 2006
(86) PCT No.: PCT/JP2006/319643

§ 371 Date: Mar. 27, 2008

(30) Foreign Application Priority Data
Sep. 28, 2005 (JP) 2005-282160

(51) Int. Cl. B29D 7/01

(52) U.S. Cl. 264/217

(57) ABSTRACT

A casting dope (27) is cast onto a running casting belt (46) to form a casting film (69). Drying devices are disposed in both surface side of the casting belt (46), so as to dry the casting film (69). The casting film (69) is conveyed through drying zones in which drying temperatures are respectively determined according to the content of remaining solvent in the casting film (69) on the basis of the graph of film production limit line that is different between the main compound of the solvent. Then the drive conditions of each drying device were set, such that the drying of the casting film (69) might be made at the drying temperature. Thus the drying temperatures are previously determined adequately to the content of remaining solvent. Therefore, the drying of the casting film can be made without a large luck of supply with the thermal energy, and the like.

### TECHNICAL FIELD

The present invention relates to a method of producing a polymer film

### BACKGROUND ART

A polymer film is used in an optical field Especially a cellulose acylate film is often used for an optical film in order to supply a reasonable and thin liquid crystal display since there is a merit of the cellulose acylate film in that it is used as a protective film in a polarizing filter

Such a polymer film is mainly produced by a solution casting method The solution casting method includes a casting process and a drying process In the casting process a polymer solution (hereinafter dope) containing many compounds (such as polymer and solvent) as cast onto a continuously running support and dried to form a casting film In the drying process the casting film is peeled from the support and dried during a transportation thereof to be a film

In the casting process since it is necessary to dry the casting film in short time the producing speed is made higher Therefore in order to dry the casting film an air feeding device is used to feed a drying air toward a casting film surface and otherwise a heating device is used to heat the support from a rear surface opposite to a casting surface on which the dope is cast Thus the drying of the casting film is made However in both methods of drying when the drying temperature as a temperature during the drying is more than the boiling point of the solvent contained in the casting film and when the drying time is too long the thermal energy supplied to the casting film is excessive Thus the solvent in the casting film evaporates to cause the foaming and otherwise the drying unevenness causes the curling The foaming and the curling decrease the planarity of the production film Therefore it is necessary to provide a method of drying the casting film without the foaming the curling

In order to reduce the foaming in the casting film in the Japanese Patent Laid-Open Publication No 61-110520 an air shielding plate is disposed to a predetermined position so as to confront to each side of the casting film Thus the drying air blows not to the support but only to the casting film formed on the support

In order to reduce the curling of the casting film in the Japanese Patent Laid-Open Publication No 2002-036263 a drying air is fed out to dry the casting film formed on a casting surface of the support and the drying temperature of the drying air is controlled Thus the temperature on the casting surface is in the predetermined range Further in the Japanese Patent Laid-Open Publication No 2003-103544 there are air feeding devices whose drying temperatures are determined according to a content of remaining solvent in the casting film

However it is not known how to set the drying temperature of the air blower and the heating device in order to prevent the curling and the forming Therefore the drying temperature is set on the basis of the experience Further the content of remaining solvent in the casting film also has an influence on the setting of the drying temperature However the relation ship of the drying temperature to the remaining solvent for preventing the curling and the foaming is not clear In followings the superordinate concept of the drying temperature and the content of remaining solvent is a drying temperature In these methods although each of the drying condition for example drying temperature or content of remaining solvent is controlled there are no quantitative data about the drying temperature at which the foaming and the curling occur Therefore in the casting/film-formation process the drying conditions are determined on the basis of the experiences and past records

In this method based on the experience the drying conditions are not clearly determined which causes several problems For example in case of using the air shielding plates if the drying temperature is too high the foaming occurs in both side edge portions of the casting film Otherwise if the drying temperature is too low the drying is not made enough and part of the casting film remains on the support after the peeling Further in order to reduce the increase of the temperature in both side edge portions a cooling air is applied to the both side edge portions In this case the drying of the both side edge portions doesn t proceed and therefore part of the casting film remains on the support after the peeling Consequently it is necessary to make the quantification of the drying conditions at which the foaming occurs in the casting film and to determine the adequate drying conditions

An object of the present invention is to provide a method of producing a polymer film excellent in planarity by reducing the foaming and the curling of the casting film excellent in planality

Another object of the present invention is to provide a method of producing a polymer film by drying a casting film on the basis of quantified drying conditions such as the drying temperature and the content of remaining solvent

### DISCLOSURE OF INVENTION

In order to achieve the objects and other objects of the present invention in a producing method of a polymer film of the present invention a dope containing a polymer and a solvent is cast onto a casting surface of an endlessly running support so as to form a casting film and an drying air is fed out from an outlet of an air feeding device confronting to the casting surface The outlet is directed in a running direction of the support further the support is heated by a heating device confronting to a rear surface of the support Setting temperatures of the air feeding device and the heating device is determined according to a content of remaining solvent in the casting film at starting the drying with use of the air feeding device and the heating device in reference with a relation between a temperature of the support and the content of remaining solvent The casting film is peeled as a polymer film from the support The polymer film is dried

Preferably the setting temperature of the heating device is almost constant in the range of 40° C. to 100° C.

Particularly preferably the air feeding device and the heating device are respectively plural and the setting temperature of each of the air feeding devices and the heating devices is adjusted independently

Preferably a main solvent compound of the solvent is dichloromethane and when a content of remaining dichloromethane in the casting film is W (mass %) the setting temperature of the air feeding device and the heating device is set such that the temperature T (° C.) of the support may satisfy a condition (I)

T≦4 5×10⁻⁴×W²−0 25×W+61 (I)

Preferably a main solvent compound of the solvent is methyl acetate and when a content of remaining methyl acetate in the casting film is W (mass %) the setting temperature of the air feeding device and the heating device is set such that the temperature T (° C.) of the support may satisfy a condition (II)

T≦6 6×10⁻⁴×W²−0 4×W+87 (II)

Preferably the peeling of the casting film is performed when the content of remaining solvent decreases to at most a predetermined value

According to the present invention when the casting film on the support is dried the drying conditions of the air drying devices and the heat drying devices can be independently determined from the film production limit line as the graph of the relation between the temperature of the support and the content of remaining solvent Thus the quantification of the drying conditions is made Therefore the foaming and the curling are prevented in the film production and the produced film is excellent in the planarity

### BRIEF DESCRIPTION OF DRAWINGS

FIG. 1 is a schematic diagram of a dope production line of the present invention

FIG. 2 is a schematic diagram of a film production line for producing a polymer film of the present invention

FIG. 3 is a partial schematic diagram in a casting chamber of the film production line of FIG. 2

FIG. 4 is a graph of film production limit line as a relation between a temperature T (° C.) of a casting belt in the casting chamber and a content of remaining solvent W (wt %) in a casting film formed on the casting belt when a main compound in the solvent is dichloromethane

FIG. 5 is a graph of film production limit line as a relation between a temperature T (° C.) of a casting belt in the casting chamber and a content of remaining solvent W (wt %) in a casting film formed on the casting belt when a main solvent compound in the solvent is methyl acetate

FIG. 6 is a partial perspective view in a casting chamber of a prior art

### BEST MODE FOR CARRYING OUT THE INVENTION

In the present invention the polymer to be used is not restricted especially and any polymers already known can be used so far as they are applied to the solution casting method As polymer in this embodiment cellulose acylate is used and especially preferably triacetyl cellulose (hereinafter TAC) As for cellulose acylate it is preferable that the degree of substitution of acyl groups for hydrogen atoms on hydroxyl groups of cellulose preferably satisfies all of following formulae (I)-(III)

2 5≦A+B≦3 0 (I)

0≦A≦3 0 (II)

0≦B≦2 9 (III)

In these formulae (I)-(III) A is the degree of substitution of the acetyl groups for the hydrogen atoms on the hydroxyl groups of cellulose and B is the degree of substitution of the acyl groups for the hydrogen atoms while each acyl group has carbon atoms whose number is from 3 to 22 Note that at least 90 wt % of TAC is particles having diameters from 0 1 mm to 4 mm However the polymer to be used in the present invention is not restricted in cellulose acylate

A glucose unit constructing cellulose with β-1 4 bond has the free hydroxyl groups on 2^{nd} 3^{rd} and 6^{th} positions Cellulose acylate is polymer in which by esterification the hydrogen atoms on the part or all of the hydroxyl groups are substituted by the acyl groups having at least two carbon atoms The degree of acylation is the degree of the esterification of the hydroxyl groups on the 2^{nd} 3^{rd} 6^{th} positions In each hydroxyl group if the esterification is made at 100% the degree of acylation is 3

Herein if the acyl group is substituted for the hydrogen atom on the 2^{nd} position in a glucose unit the degree of the acylation is described as DS2 (the degree of substitution by acylation on the 2^{nd} position) and if the acyl group is substituted for the hydrogen atom on the 3^{rd} position in the glucose unit the degree of the acylation is described as DS3 (the degree of substitution by acylation on the 3^{rd} position) Further if the acyl group is substituted for the hydrogen atom on the 6^{th} position in the glucose unit the degree of the acylation is described as DS6 (the degree of substitution by acylation on the 6^{th} position) The total of the degree of acylation DS2+DS3+DS6 is preferably 2 00 to 3 00 particularly 2 22 to 2 90 and especially 2 40 to 2 88 Further DS6/(DS2+DS3+DS6) is preferably at least 0 28 particularly at least 0 30 and especially 0 31 to 0 34

In the present invention the number and sort of the acyl groups in cellulose acylate may be only one or at least two If there are at least two sorts of acyl groups one of them is preferable the acetyl group If the hydrogen atoms on the 2^{nd} 3^{rd} and 6^{th} hydroxyl groups are substituted by the acetyl groups the total degree of substitution is described as DSA and if the hydrogen atoms on the 2^{nd} 3^{rd} and 6^{th} hydroxyl groups are substituted by the acyl groups other than acetyl groups the total degree of substitution is described as DSB In this case the value of DSA+DSB is preferably 2 22 to 2 90 especially 2 40 to 2 88 Further DSB is preferably at least 0 30 and especially at least 0 7 According to DSB the percentage of the substitution on the 6^{th} position to that on the 2^{nd} 3^{rd} and 6^{th} positions is at least 20% However the percentage is preferably at least 25% particularly at least 30% and especially at least 33% Further DSA+DSB of the 6^{th} position of the cellulose acylate is preferably at least 0 75 particularly at least 0 80 and especially at least 0 85 When these sorts of cellulose acylate are used a solution (or dope) having excellent solubility can be produced Especially in non-chrorine type, organic solvent is excellent in solubility and used for preparing the dope which has low viscosity and filterability

Cellulose as a raw material of cellulose acylate may be obtained from linter cotton or pulp However the preferable cellulose acylate is obtained from linter cotton

In cellulose acylate the acyl group having at least 2 carbon atoms may be aliphatic group or aryl group and is not restricted especially Such cellulose acylate is for example alkylcarbonyl ester and alkenylcarbonyl ester of cellulose Further there are aromatic carbonyl ester aromatic alkyl carbonyl ester or the like and these compounds may have other substituents As preferable examples of the compounds there are propionyl group, butanoyl group pentanoly group hexanoyl group octanoyl group decanoyl group dodecanoyl group tridecanoyl group tetradecanyol group hexadecanoyl group octadecanoyl group iso-butanoyl group t-butanoyl group cyclohexanecarbonyl group oleoyl group benzoyl group naphthylcarbonyl group cinamoyl group and the like Among them the particularly preferable groups are propionyl group butanoyl group dodecanoyl group octadecanoyl group t-butanoyl group oleoyl group benzoyl group naphthylcarbonyl group cinamoyl group and the like and the especially preferable groups are propionyl group and butanoyl group

The detail explanation of cellulose acylate is made from [0140] to [0195] in Japanese Patent Laid-Open Publication No 2005-104148 The description of this publication is also applied to the present invention

Further as solvents for preparing the dope there are aromatic hydrocarbons (for example benzene toluene and the like) hydrocarbon halides (for example, dichloromethane chlorobenzene and, the like) alcohols (for example methanol ethanol n-propanol n-butanol diethyleneglycol and the like) ketones (for example acetone methylethyl ketone and the like) esters (for example methyl acetate ethyl acetate propyl acetate and the like) ethers (for example tetrahydrofuran methylcellosolve and the like) and the like Note that the dope may be a solution or a dispersion

The solvents are preferably hydrocarbon halides having 1 to 7 carbon atoms and especially dichloromethane Then in view of the solubility of cellulose acylate the peelability of a casting film from a support a mechanical strength of a film, optical properties of the film and the like it is preferable that one or several sorts of alcohols having 1 to 5 carbon atoms is mixed with dichloromethane Thereat the content of the alcohols to the entire solvent is preferably in the range of 2 mass % to 25 mass % and particularly in the range of 5 mass % to 20 mass % Concretely there are methanol ethanol n-propanol iso-propanol n-butanol and the like The preferable examples for the alcohols are methanol ethanol n-butanol or a mixture thereof.

By the way recently in order to reduce the effect to the environment to the minimum the solvent composition when dichloromethane is not used is progressively considered In order to achieve this object ethers having 4 to 12 carbon atoms ketones having 3 to 12 carbon atoms esters having 3 to 12 carbon atoms, and alcohols having 1 to 12 carbon atoms are preferable and a mixture thereof can be used and for example there is a mixture of methyl acetate acetone ethanol and n-butanol These ethers ketones esters and alcohols may have the ring structure Further the compounds having at least two of functional groups (namely —O— —CO— —COO— and —OH) in ethers ketones esters and alcohols can be used for the solvent

The additives (such as the solvent plasticizer deterioration inhibitor UV absorbing agent optically anisotropic controller retardation controller dyne matting agent release agent releasing accelerator and the like) are described in detail from [0196] to [0516] of Japanese Patent Laid-Open Publication No 2005-104148

[Dope Production Method]

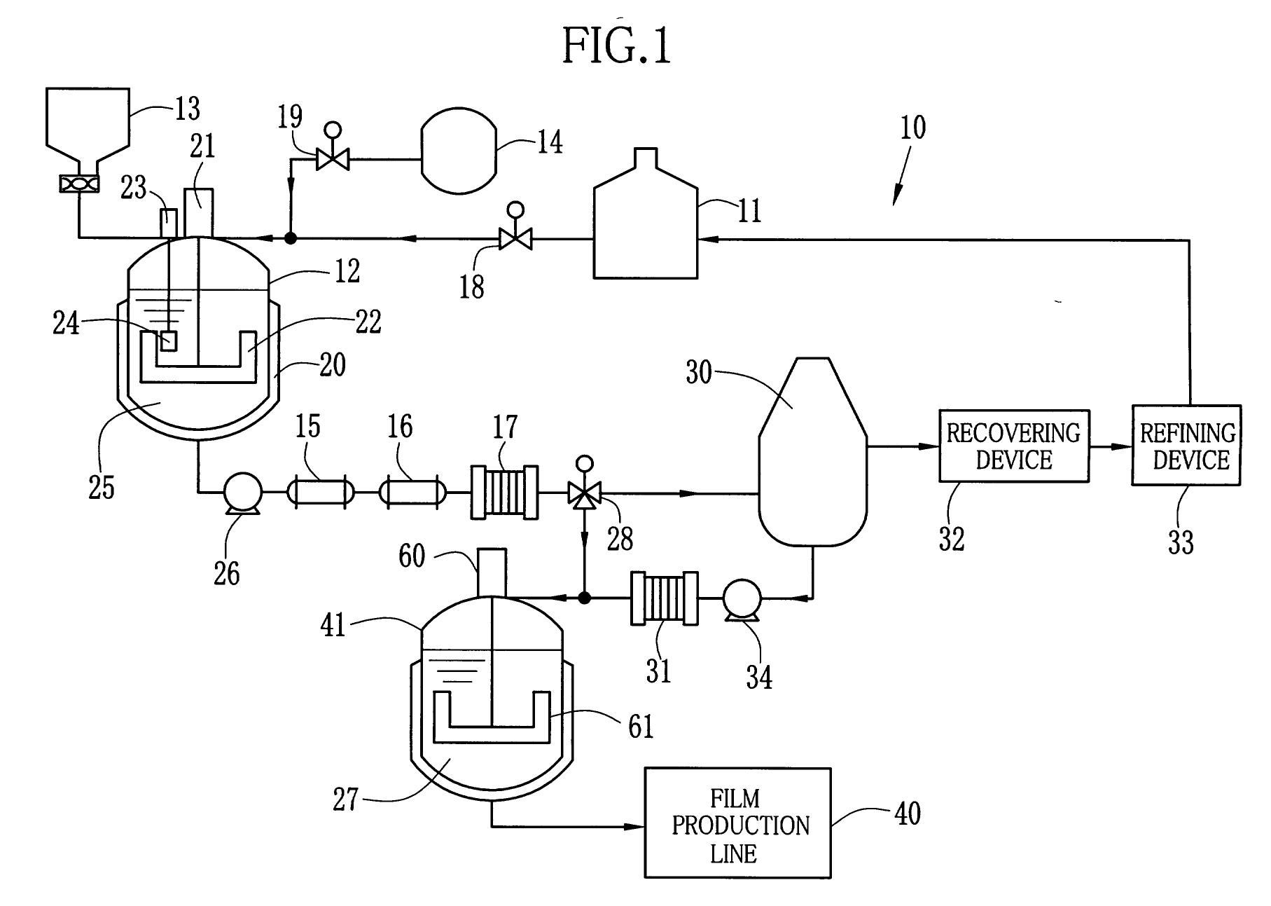

A dope production line and a dope production method will be explained in reference with FIG. 1 However the following explanation will describe only an example of the present invention and therefore the present invention is not restricted in the embodiment A dope production line 10 is constructed of a solvent tank 11 for storing a solvent an additive tank 14 for storing an additive a hopper 13 for supplying the TAC and a mixing tank 12 for mixing the TAC and the solvent therein Further there is a heating device 15 for heating a mixture liquid 25 (described below in detail) a temperature controller 16 for controlling the temperature of the mixture liquid 25 such that a prepared dope may be obtained Further, in downstream from the temperature controller 16 there is a filtration device 17 for filtrating the dope a flushing device 30 for concentrating the dope and a filtration device 31 for filtrating the concentrated dope

Furthermore there are a recovering device 32 for recovering a solvent vapor and a refining device 33 for refining and recycling the recovered solvent The dope production line 10 is connected through a stock tank 41 for storing a casting dope 27

In the dope production line 10 the casting dope 27 is produced in the following order A valve 19 is opened such that the additive in the additive tank 14 may be sent to the mixing tank 12 Thereafter the solvent in the solvent tank 11 and the TAC in the hopper 13 are sent to the mixing tank 12 Note that the necessary amount of the additive solvent is adjusted by opening and closing the valve 19 for feeding the additive from the additive tank 14 to the mixing tank 12

Further the method of feeding the additive to the mixing tank 12 is not restricted in the above description If the additive is in the liquid state in the room temperature it may be fed in the liquid state to the mixing tank 12 without preparing for the additive solution Otherwise if the additive is in the solid state in the room temperature it may be fed in the solid state to the mixing tank 12 with use of a hopper If plural sorts of additive compounds are used the additive containing the plural additive compounds may be accumulated in the additive tank 14 altogether Otherwise plural additive tanks may be used so as to contain the respective additive compounds which are sent through independent pipes to the mixing tank 12

In the above explanation the additive the TAC and the solvent are sequentially sent to the mixing tank 12 However the sending order is not restricted in it For example after the predetermined amount of the TAC is sent to the mixing tank 12 the feeding of the predetermined amount of the solvent and the additive may be performed to obtain a TAC solution Otherwise it is not necessary to feed the additive to the mixing tank 12 previously and the additive may be added to a mixture of TAC and solvent in following processes in considering of the sort and characteristics of the additive

The mixing tank 12 is provided with a Jacket 20 covering over an outer surface of the mixing tank 12 a first stirrer 22 to be rotated by a motor 21 and a second stirrer 24 to be rotated by a motor 23 The first stirrer 22 preferably has an anchor blade and the second stirrer 24 is preferably an eccentric stirrer of a dissolver type

The inner temperature in the mixing tank 12 is controlled by a heat transfer medium in the jacket 20 The preferable inner temperature is in the range of −10° C. to 55° C. The solubility of the cellulose acylate can be adjusted depending on the type of the first and second stirrers 22 24 the sort of cellulose acylate the sort of the solvent and the like In this embodiment the dissolution of the mixture of the TAC the solvent and the additive in a mixture liquid 25 is made such that the TAC may be swollen in the solvent

A pump 26 is driven such that the mixture liquid 25 in the mixing tank 12 may be sent to the heating device 15 which is preferably a pipe with a Jacket The heating device 15 may be preferably provided with a pressuring device so as to progress the dissolution effectively When the heating device 15 is used the dissolution of solid compounds proceeds such that a dope may be obtained Hereinafter this method is called a heat-dissolution method The temperature of the mixture liquid 25 is preferably in the range of 50° C. to 120° C.

Instead of the heat-dissolution with use of the heating device 35 the mixture liquid 25 may be cooled in the range of −100° C. to −30° C. so as to perform the dissolution which is already known as the cool-dissolution method In this embodiment one of the heat-dissolution and cool-dissolution methods can be chosen in accordance with the properties of the materials so as to control the solubility

The heated mixture liquid 25 is sent to a temperature controller 16 to control the temperature of the mixture liquid 25 nearly to a room temperature From the temperature controller 16 is fed out the mixture liquid 25 as the dope in which the polymer is dissolved However the TAC is usually dissolved completely when fed out from the heating device 15

Then the filtration of the dope is made in the filtration device 17 such that impurities and undissolved materials may be removed from the dope The filter material of the filtration device 17 preferably has an averaged nominal diameter of at most 100 μm The flow rate of the filtration in the filtration device 17 is preferably at least 50 liter/hr The dope after the filtration is fed through a valve 28 and thus stored as a casting dope 27 in the stock tank 41

The dope can be used as the casting dope 27 for a film production which will be explained However in the method in which the dissolution of TAC is performed after the preparation of the mixture liquid 25 if it is designated that a dope of high concentration is produced the time for production of such dope becomes longer Consequently, the production cost becomes higher Therefore it is preferable that a dope of the lower concentration than the predetermined value is prepared at first and then the concentrating of the dope is made In this embodiment the dope after the filtration is sent to the flushing device 30 through the valve 28 In the flushing device 30 the solvent of the dope is partially evaporated The solvent vapor generated in the evaporation is condensed by a condenser (not shown) to a liquid state and recovered by the recovering device 32 The recovered solvent is recycled by the refining device 33 and reused According to this method the decrease of cost can be designated since the production efficiency becomes higher and the solvent is reused

The dope after the concentrating as the above description is extracted from the flushing device 30 through a pump 34 Further in order to remove bubbles generated in the dope it is preferable to perform the bubble removing treatment As a method for removing the bubble there are many methods which are already known for example an ultrasonic irradiation method and the like Then the dope is fed to the filtration device 17 in which the undissolved materials are removed Note that the temperature of the dope in the filtration device 17 is preferably in the range of 0° C. to 200° C. The dope after the filtration is stored as the casting dope 27 in the stock tank 41 which is provided with the first stirrer 22 rotated by a motor 60 The first stirrer 22 is rotated so as to continuously stir the casting dope 27

Thus a dope produced the produced dope preferably has the TAC concentration in the range of 5 mass % to 40 mass % particularly 15 mass % to 30 mass % and especially 17 mass % to 25 mass % Further the concentration of the additive (mainly plasticizer) is preferably in the range of 1 mass % to 20 mass % if the solid content in the casting dope 27 is 100 mass %

Note that the method of producing the casting dope 27 as disclosed in detail in [0517] to [0616] in Japanese Patent Laid-Open Publication No 2005-104148 for example the dissolution method and the adding methods of the materials the raw materials and the additives in the solution casting method for forming the TAC film the filtering method the bubble removing method, and the like

[Solution Casting Method]

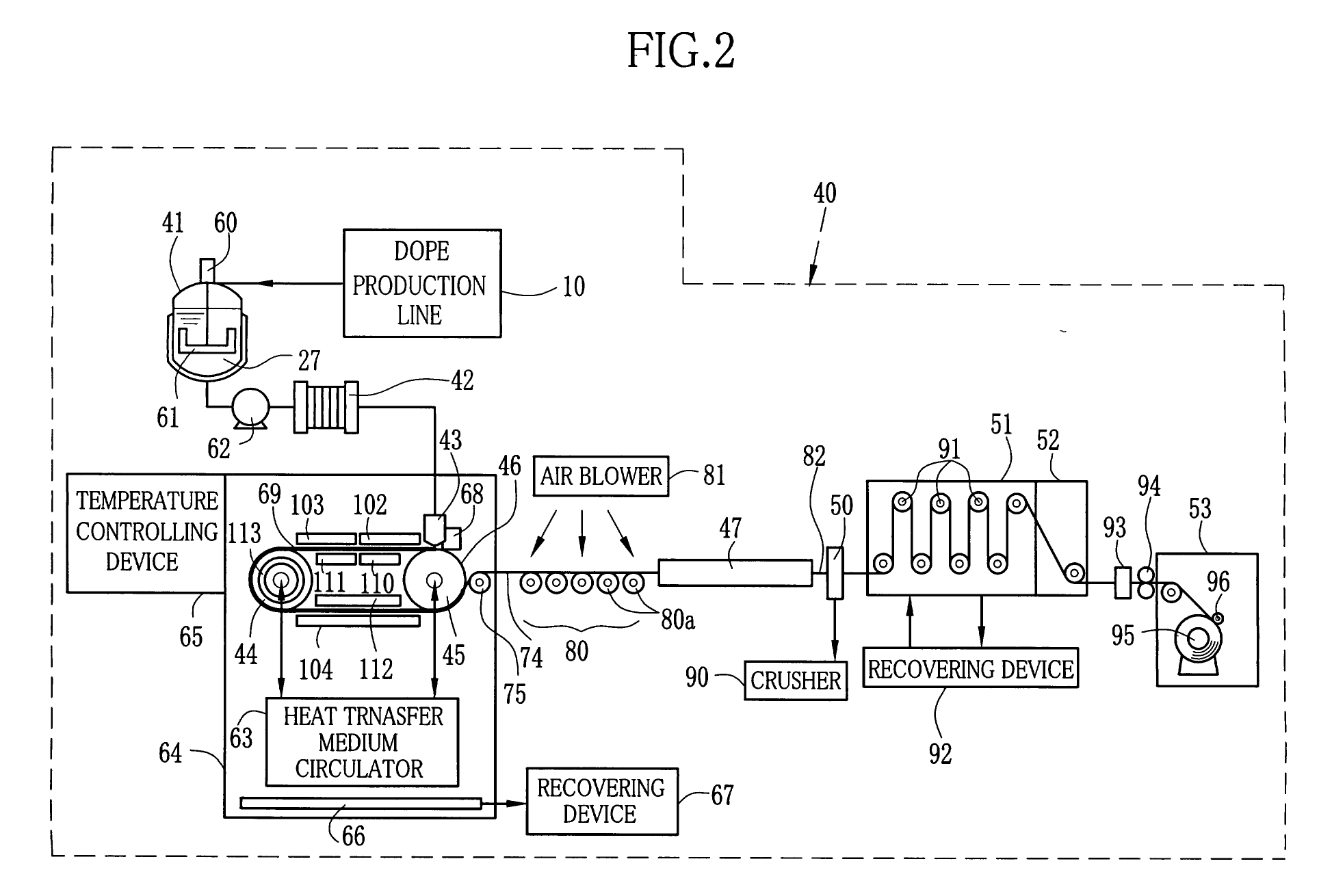

An embodiment of the solution casting method will be described in reference with FIG. 2 now However the present invention is not restricted in the embodiment

A film production line 40 has the stock tank 41a filtration device 42 and a casting chamber 64 which includes back-up rollers 44 45 and a casting belt 46 supported by the back-up rollers 44 45 The casting belt 46 continuously runs in accordance with the rotation of the back-up rollers 44 45 Furthermore the casting chamber 64 has a casting die 43 for casting the casting dope 27 onto a casting surface of the casting belt 46 so as to form a casting film 69 and a peel roller 75 for peeling the casting film 69 as a film 82 and supporting the film 82 The back-up rollers 44 45 are connected with a heat transfer medium circulator 63 for circulatory feeling a heat transfer medium to the back-up rollers 44 45 such that the surface temperatures of the back-up rollers 44 45 may be constant Further the cast dope 22 forms a bead between the casting die 43 and the casting belt 46 In order control the pressure in a rear side of the bead it is preferable to dispose a decompression chamber 68 for making the decompression of the rear side from the bead

The materials of the casting die 43 are preferably precipitation hardening stainless steel having a mixture composition of austenite phase and ferrite phase The preferable material has coefficient of thermal expansion of at most 2×10⁵(° C.¹) Further the material to be used has an anti-corrosion property which is almost the same as SUS316 in the examination of forcible corrosion in the electrolyte solution Preferably the materials to be used for the casting die 22 has such resistance of corrosion that the pitting doesn t occur on the gas-liquid interface even if the material is dipped in a mixture of dichloromethane methanol and water for three months The casting die 43 is preferably manufactured by performing the grinding after a month from the material casting Thus the surface condition of the dope flowing in the casting die 43 is kept uniform

The finish precision of a contact face of the casting die to dope 22 is at most 1 μm in surface roughness and at most 1 μm/m an straightness The clearance of a slit of the casting die 43 is automatically adjustable in the range of 0 5 mm to 3 5 mm According to an edge of the contact portion of a lip end of the casting die 43 to the dope R(R is chamfered radius) is at most 50 μm in all of a width Further the shearing rate in the casting die 43 is controlled in the range of 1 to 5000 per second

A width of the casting die 43 is not restricted especially However the width is preferably at least 1 1 times and at most times as large as a film width Furthermore the casting die 43 is preferably a coat hanger type die Further in order to adjust a film thickness the casting die 43 is preferably provided with an automatic thickness adjusting device For example thickness adjusting bolts (heat bolts) are disposed at a predetermined distance in a widthwise direction of the casting die 43 According to the heat bolts it is preferable that the profile is set on the basis of a predetermined program depending on feed rate of a pump 62 (preferably high accuracy gear pumps) while the film production is performed

Further the film production line 40 may be provided with a thickness meter (not shown) such as infrared ray thickness meter and the like In this case the feed back control of the adjustment value of the heat bolts may be made by the adjusting program on the base of the profile of the thickness meter The thickness difference between any two points in the widthwise direction except the side edge portions in the casting film is controlled preferably to at most 1 μm The difference between the maximum and the minimum of the thickness in the widthwise direction is at most 3 μm and especially at most 2 μm Further the accuracy to the designated object value of the thickness is preferably in ±1 5 μm

Preferably a hardened layer is preferably formed on a top of a lip end of the casting die 43 A method of forming the hardened layer is not restricted But it is for example ceramics hard coating hard chrome plating neutralization processing and the like If ceramics is used as the hardened layer it is preferable that the used ceramics is grindable but not friable with a lower porosity high resistance of corrosion and poor adhesiveness to the casting die 43 Concretely there are tungsten carbide (WC), Al₂O₃ TiN Cr₂O₃ and the like Especially preferable ceramics is tungsten carbide Tungsten carbide coating can be made by a spraying method

Further in order to prevent the partial dry-solidifying of the casting dope 27 flowing on slit ends of the casting die 43 it is preferable to provide a solvent supplying device (not shown) at the slit ends on which a gas-liquid interfaces are formed between both edges of the slit and between both bead edges and the outer gas Preferably these gas-liquid interfaces are supplied with the solvent which can dissolve the dope (for example a mixture solvent of dichloromethane 86 5 pts mass acetone 13 pts mass n-butanol 0 5 pts mass) The supply rate to each slit end is preferably in the range of 0 1 mL/min to 1 0 mL/min in order to prevent the foreign materials from mixing into the casting film Note that the pump for supplying the solvent has a pulse rate (or ripple factor) at most 5%

Then the solution casting method performed by the film production line 40 will be described in followings The back-up roller 45 (in the downstream side from the casting die 43) is rotated by a driver (not shown) Thus the casting belt 46 endlessly runs The casting speed in preferably in the range of 10 m/min to 200 m/min

The temperature of the back-up rollers 44 45 is controlled with use of the heat transfer medium circulator 63 By the heat transfer from the back-up rollers 44 45 the surface temperature of the casting belt 46 is controlled in the range of −20° C. to 40° C. Note that paths (not shown) of the heat transfer medium are provided in the back-up rollers 44 45 The heat transfer medium whose temperature is controlled by the heat transfer medium circulator 63 is fed through the paths such that the temperature of the back-up rollers 44 45 are kept to predetermined values

The width the length and the material of the casting belt 46 are not restricted especially However it is preferably 1 1 to 2 0 times as large as the casting width Preferably the length is from 20 m to 200 m and the thickness is from 0 5 mm to 2 5 mm The surface of the casting belt 46 is grinded such that the surface roughness may be at most 0 05 μm The casting belt 46 described above is produced preferably of stainless and especially from SUS316, since it has an enough resistance to corrosion and strength Further the thickness unevenness of the casting belt 46 is preferably at most 0 5%

Note that it is possible to use one of the back-up rollers 44 45 as support In this case the back-up roller used as support is preferably rotated at high accuracy such that a rotation flutter may be at most 0 2 mm Therefore the surface roughness is preferably at most 0 01 μm Further the chrome plating is preferably performed to the drum such that the drum may have enough hardness and endurance As described above it is preferable in the support that the surface defect must be reduced to be minimal Concretely there are no pin hole of at least 30 μm at most one pin hole in the range of 10 μm to 30 μm, and at most two pin holes of less than 10 μm per 1 m²

There is a temperature controlling device 65 for controlling the inner temperature of the casting chamber 64 to the predetermined value and a condenser 66 for condensing organic solvent evaporated in the casting chamber 64 Further a recovering device 67 for recovering the condensed organic solvent outside the casting chamber 64 Further the cast dope forms a bead between the casting die 43 and the casting belt 46 In order control the pressure in a rear side of the bead it is preferable to dispose the decompression chamber 68 as in this embodiment

Further the casting chamber 64 is provided with first-third air ducts 102-104 for feeding airs The first air duct 102 is disposed so as to be at the most upstream position among the three air ducts 102-104 namely in a downstream from and close to the casting die 43 Thus the first air duct 102 is disposed in an upper and upstream side The second air duct 103 in an upper and downstream side from the air duct 102 The third air duct 104 is disposed at the most downstream position Furthermore there are first-third heating devices 110-112 for heating the casting belt 46 are disposed so as to respectively confront to the air ducts 102-104 Therefore the casting belt 46 runs between the first air duct 102 and the heating device 110 the second air duct 103 and the second heating device 111 and the third air duct 104 and the third heating device 112 Further in the back-up roller 44 a fourth heating device 113 is fixed for heating the back-up roller 44 and the back-up roller 113 rotates around the fourth heating device 113 In the downstream from the casting chamber 64 the peel roller 75 is disposed for peeling the casting film 64 as the wet film 74 from the casting belt 46 and supporting the wet film 74 Note that the collective term of first-third air ducts 102-104 and first-fourth heating devices 110-113 is “drying device” in this embodiment

In the transfer area 80 there are a plurality of rollers 80a and an air blower 81 In the downstream from the transfer area 80 a tenter device 47 and an edge slitting device 50 are disposed The edge slitting device 50 slits off both side edge portions of the film 82 into tips and the tips of both side edge portions are crushed by a crusher 90 which is connected to the edge slitting device 50 Note that the detailed explanation of the tenter device 47 will be made later

In a drying chamber 51 the film 82 is transported with lapping on many rollers 91 The solvent vapor evaporated from the film 82 by the drying chamber 51 is adsorbed and recovered by a recovering device 92 The film 82 is transported into a cooling chamber 52 and cooled down Note in this figure that cooling chamber 52 follows to the drying chamber 51 However a moisture controlling chamber (not shown) may be disposed between the drying chamber 51 and the cooling chamber 52

Thereafter a compulsory neutralization device (or a neutralization bar) 93 eliminates the charged electrostatic potential of the film 82 to the predetermined value (for example in the range of −3 kV to +3 kV) The position of the neutralization process is not restricted in this embodiment For example the position may be a predetermined position in the drying section or in the downstream side from the knurling roller 94 and otherwise the neutralization may be made at plural positions After the neutralization the embossing of both side portions of the film 82 is made by the embossing rollers to provide the knurling Then the film 82 is wound by a winding shaft 95 in a winding chamber 53 At this moment a winding tension is applied at the predetermined value by a press roller 96

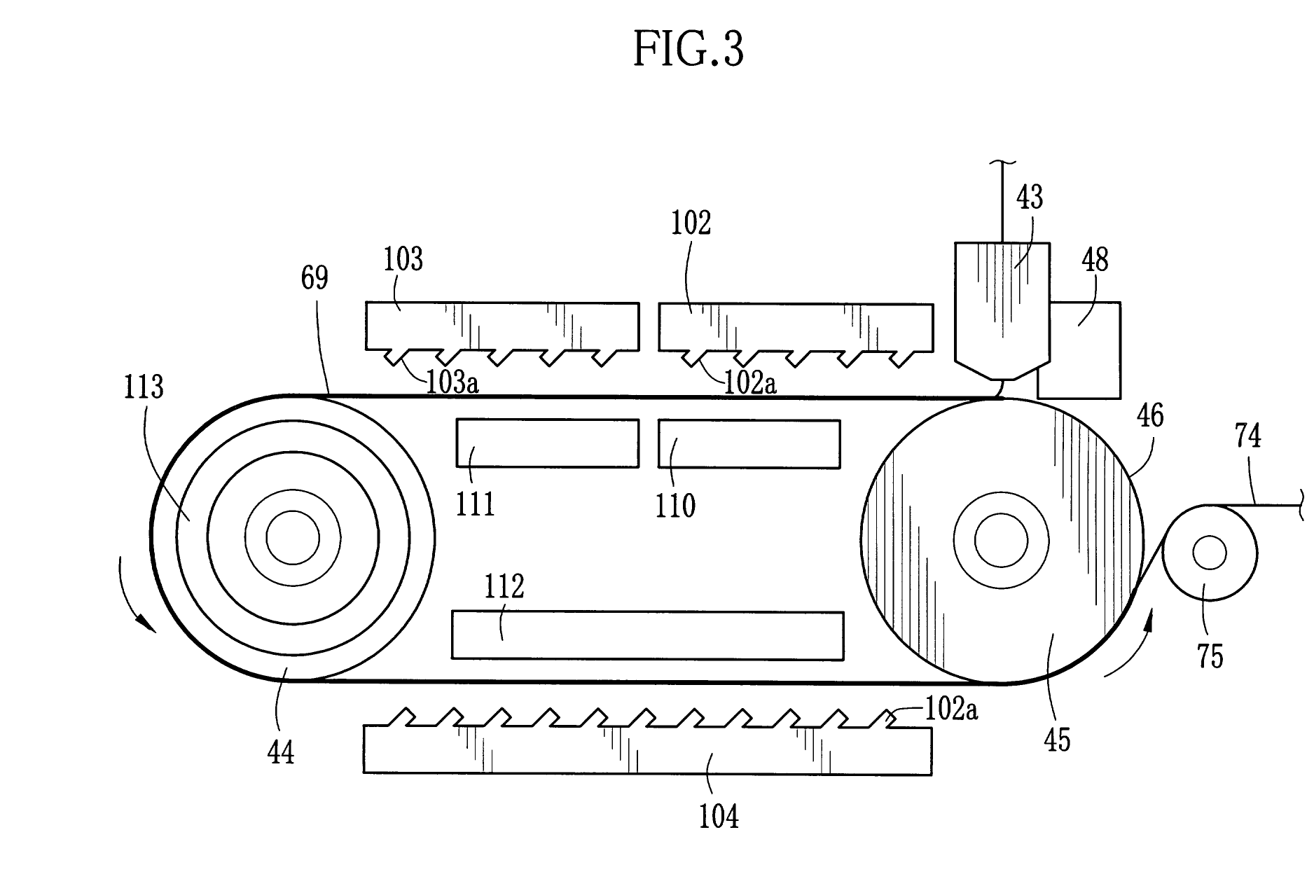

In FIG. 3 the first-third air ducts 102-104 confront to the casting surface of the casting belt 46 onto which the casting dope 27 is to be cast and respectively have first-third outlets 102a 103a 104a for feeding out a drying air in a running direction of the casting belt 46 The temperatures of the drying airs fed out from the outlets 102a 103a 104a are controlled to respectively predetermined values Thus the drying of the casting film 69 is made by applying the drying air

Each first-fourth heating devices 110-113 confronts to a rear surface of the casting belt 46 which is opposite to the casting surface The setting temperatures of the first-fourth heating devices 110-113 are set to respectively predetermined values Thus the drying of the casting film is also made by the first-fourth heating devices 110-113

Since the setting temperatures of the first-third air ducts 102-104 and the first-third drying devices 110-112 are adjusted independently Further the first air duct 102 confronts to the first drying device 110 the second air duct 103 confronts to the second drying device 111 and the third air duct 102 confronts to the third drying device 112 Therefore there are first-third drying zones The first drying zone is around the first air duct 102 and the first drying device 110 the second drying zone is around the second air duct 103 and the second drying device 111 and the third drying zone is around the third air duct 102 and the third drying device 112

The drying temperatures of the first-third drying zones are adjusted so as to satisfy a certain temperature range In this embodiment the drying temperature is controlled by adjusting the setting temperature of each air duct 102-104 and the setting temperature of each heating device 110-103 The setting temperatures of the first-third air ducts 102-104 and the first-fourth heating devices 110-113 are determined in accordance with the content of remaining solvent in the casting film 69 at a position of each device The method of determining the setting temperatures will be explained later in detail Note in this embodiment a thermometer is disposed in each drying zone

The content of remaining solvent in the casting film 69 is a content of remaining main solvent in the casting film 69 If the solvent is a mixture solvent in which several solvent compounds are mixed the content of remaining main compound is defined as a content of remaining solvent The content of remaining solvent is on the dry basis If the sample weight of the casting film 69 is x and the sample weight after the drying is y the solvent content on the dry basis (%) is calculated in the formula {(x−y)/y}×100 Note that in the content of the remaining solvent on dry basis the weight of the solid obtained by completely drying the dope corresponds to 100% Note that a part of the casting film is sampled in the film production and the content of remaining solvent is obtained by the above method

Just before peeling the casting film 69 from the casting belt 46 the temperature of an area of the rear surface of the casting belt 46 is controlled almost to a predetermined value in the range of 40° C. to 100° C. such that the drying may be made In this embodiment the setting temperature of the third heating device 112 is adjusted to a predetermined value in the range of 40° C. to 100° C. Thus just before the peeling from the casting belt 46 the drying of the casting film 69 is expedited and therefore part of the casting film 69 doesn t remain on the casting belt 46 after the peeling

Just after the formation of the casting film 69 on the casting belt 46 in both sides of the casting surface and the rear surface of the casting belt 46 a plurality of the drying devices is disposed in a transporting direction In this embodiment the first air duct 102 and the second air duct 103 are disposed in the side of the casting surface of the casting belt 46 Further the first heating device 110 is disposed oppositely of the casting belt 46 to the first air duct 102 so as to confront to the rear surface of the casting belt 46 The second heating device 111 is disposed oppositely of the casting belt 46 to the second air duct 103 so as to confront to the rear surface of the casting belt 46

By using these devices the casting film 69 is dried at the drying temperatures in accordance with the content of remaining solvent in the casting film 69 Thus the thermal energy is supplied enough to the casting film 69 and lower than the film production limit over which the curling and the foaming occur Note that the setting temperature of each drying device is preferably set higher in the downstream side In this case the evaporation of the solvent is made gradually and therefore the foaming and the curling are reduced effectively

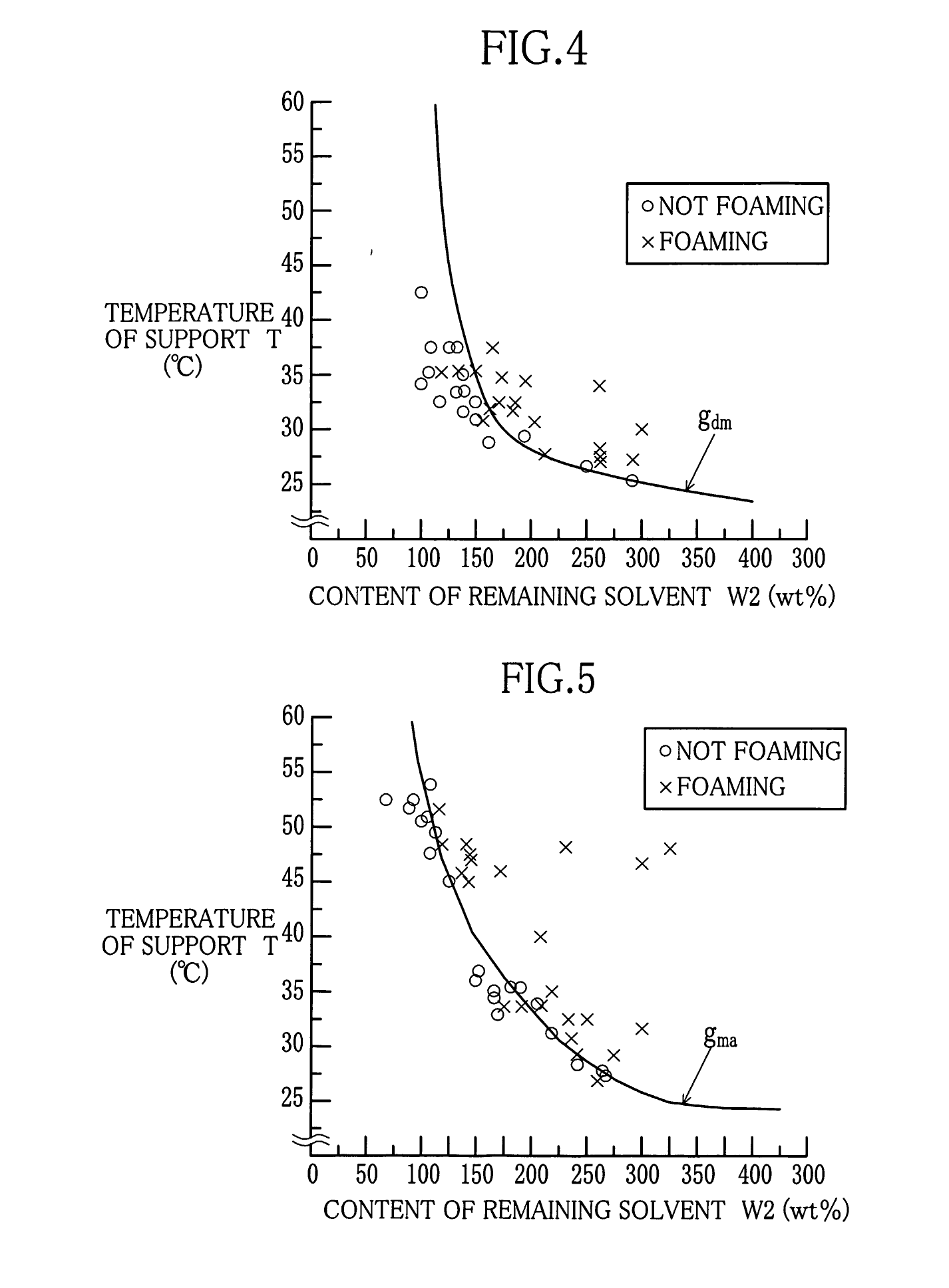

The setting temperature of each drying device is determined on the basis of the content of remaining solvent in the casting film 69 such that the foaming doesn t occur In FIGS. 4 & 5 the temperature of the casting belt 46 is T (° C.) and the content of remaining solvent is W (wt %) The relation between W and T is obtained in an experiment previously made In this embodiment the content of remaining solvent W in the casting film 69 is the content of a remaining main solvent compound the compound contained in the casting film 69 at most among the solvent compounds

However the occurrence of the foaming also depends on the sorts of the main solvent compounds In FIG. 4 the main solvent compound is dichloromethane

Around 150 wt % of the content of the remaining solvent W if the temperature T of the casting belt 461s around in the range of 30° C. to 32° C. the foaming doesn t occur However if the temperature T of the casting belt 46 is at least 35° C. the foaming occurs Otherwise around 200 wt % of the content of the remaining solvent W if the temperature T of the casting belt 46 is at most 30° C. the foaming and the curling don t occur and therefore the produced film has adequate to the optical use However if the temperature T of the casting belt 46 is at least 30° C. the foaming occurs This tendency is observed also when the content of remaining solvent W is the other value Consequently even at the same value of the content of the remaining solvent W if the temperature T changes the foaming sometimes occurs Thus the film production limit line g_{dm} can be represented as a graph of relation between the temperature T (° C.) of the casting belt 46 and the content of remaining solvent W (wt %)

The graph g_{dm} can be represented in following formula

T=4 5×10⁻⁴×W²−0 25×W+61

Further the region of production possibility without foaming and curling is represented in following formula (I)

T≦4 5×10⁻⁴×W²−0 25×W+61 (I)

However the content of remaining solvent W satisfies a condition 80<W<350 Note that the temperature T1 is not restricted especially However it satisfies a preferable condition 25(° C.)<T<100(° C.)

In FIG. 5 the main solvent compound is methyl acetate

Around 150 wt % of the content of the remaining solvent W if the temperature T of the casting belt 46 is at most around 35° C. the foaming and the curling don t occur and therefore the produced film has adequate to the optical use However if the temperature T of the casting belt 46 is at least around 45° C. the foaming occurs Otherwise around 200 wt % of the content of the remaining solvent W if the temperature T of the casting belt 461s at most around 38° C. the foaming and the curling don t occur and therefore the produced film has adequate to the optical use However if the temperature T of the casting belt 46 is at least around 40° C. the foaming occurs Consequently also in the embodiment of methyl acetate as the main solvent compound the film production limit line gₘₐ can be represented as a graph of relation between the temperature T (° C.) of the casting belt 46 and the content of remaining solvent W (wt %) in the casting film 69

The graph g_{dm} can be represented in following formula

T=6 6×10⁻⁴×W²−0 4×W+87

Further the region of production possibility without foaming and curling is represented in following formula (I)

T≦6 6×10⁻⁴×W²−0 4×W+87 (II)

However the content of remaining solvent W satisfies a condition 80<W<350 Note that the temperature T1 is not restricted especially However it satisfies a preferable condition 25(° C.)<T<100(° C.)

In the present invention if the main solvent compound is dichloromethane the temperature of the casting belt 46 is determined on the basis of the formula (I) and if the main solvent compound is methyl acetate the temperature of the casting belt 46 is determined on the basis of the formula (II) Then the setting temperatures of the drying devices are determined on the basis of the determined temperature of the casting belt 46 Thus each drying temperature is controlled to be almost constant such that the foaming and the curling may not occur Therefore the produced film has adequate to the optical use

For example, if the main solvent compound is dichloromethane the content of remaining solvent W near the first air duct 102 is 300 wt % the formula (I) teaches the temperature T of the casting belt 46 must satisfy a condition T(° C.)≦26 5 The setting temperature of the first air duct 102 is determined such that the temperature T of the casting belt 46 may be at most 26 5° C. Then the setting temperature of the first air duct 102 is adjusted so as to control the drying temperature of the first drying zone in the predetermined range The drying air is fed out from the first air duct 102 parallel to the running direction of the casting belt 46 so as dry the casting film 69 Note that the setting temperatures of the other drying devices are determined in the same manner as the first drying duct 102

As described above on the basis of the graph of the film production limit line the temperature of the casting belt 46 is determined in accordance with the content of the remaining solvent and then the setting temperatures of the drying devices are controlled Thereafter the drying is performed Thus the drying temperature doesn t become too high and too low Further the temperature at which the curling occurs is usually higher than the temperature at which the foaming occurs Therefore the curling is also effectively prevented in the present invention

Therefore the foaming and the curling are reduced and it is also reduced that part of the casting film 69 may remain on the casting belt 46 after the peeling

If it is designated to dry the casting film 69 with the drying air by the first-third air ducts 102-104 disposed in the side of the casting surface of the casting belt 46 it is preferable that the casting film 69 is conveyed in at least three temperature zones in which the drying temperatures are respectively determined Therefore the setting temperature of each air duct 102-104 is independently controlled to a predetermined value in the range of 40° C. to 140° C.

If it is designated to dry the casting film 69 by the first-fourth heating devices 110-113 disposed so as to confront to the rear surface of the casting belt 46 it is preferable that the casting film 69 is conveyed through the at least three drying zones in which the drying temperatures respectively determined The setting temperature of each heating device 110-113 is controlled in accordance with the content of remaining solvent in the casting film 69 Note in the present invention that the setting temperature of the first heating device 110 is at most 25° C. that of the second heating device 111 is in the range of 25° C. to 35° C. that of the third heating device 112 is in the range of 40° C. to 100° C. and that of the fourth heating device 113 is in the range of 35° C. to 45° C. Thus the setting temperature of each heating device is controlled to a predetermined value

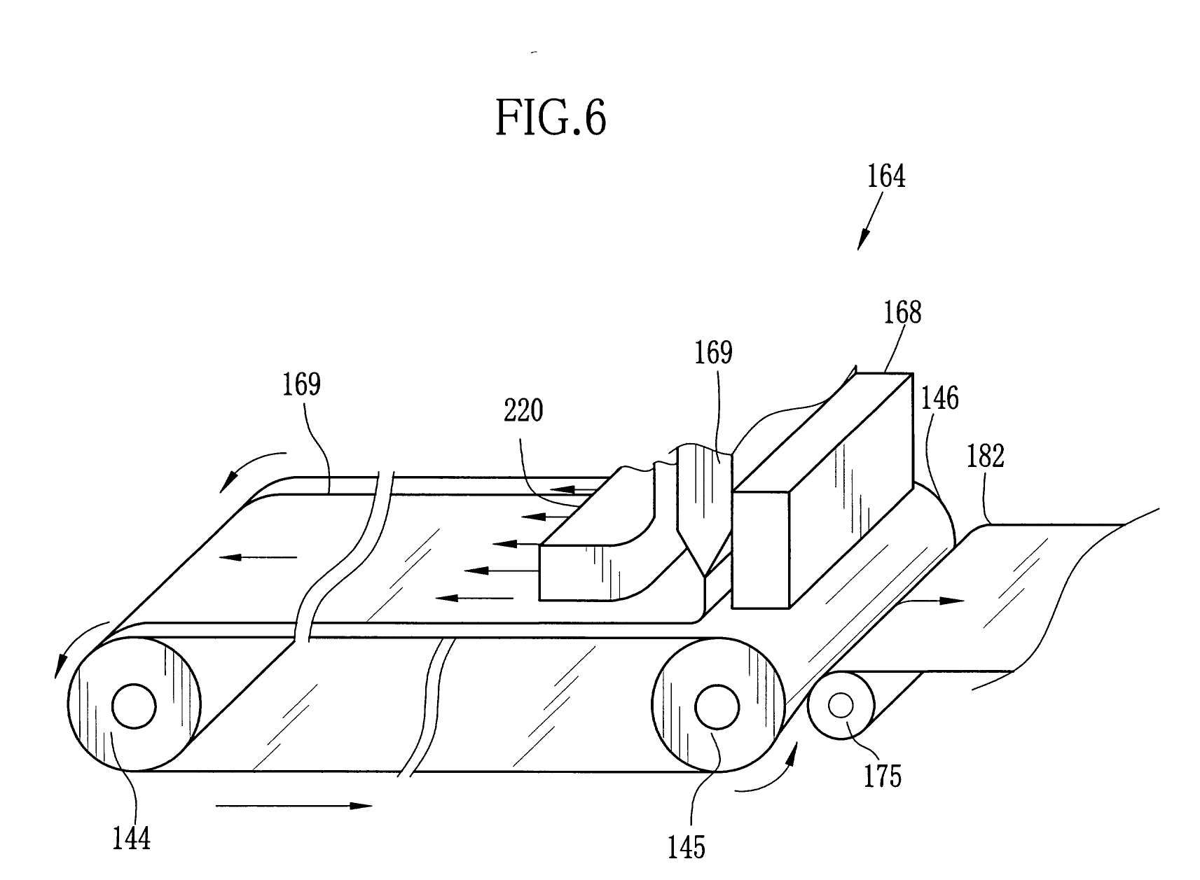

As shown in FIG. 6 in the prior art an air duct 220 is disposed above a casting belt 146 in upper side In a casting chamber 146 a casting dope is cast from the casting die 143 onto a casting belt 146 so as to form the casting film 169 while the casting belt 146 is supported by back-up rollers 144 145 The back side from a bead of the casting dope is decompressed by a decompression chamber 168 A drying air is fed out from an outlet (not shown) of the air duct 220, such that the drying air may blow almost in parallel to a running direction of the casting belt 146 However in this case the drying is made only in one side namely in a side of a casting surface of the casting belt 146 After the drying the casting film is peeled as a film 182 from the casting belt 146 In this case a thermal energy to be supplied for drying the casting film 169 is not enough Therefore the drying speed cannot be higher

However as in the present invention a plurality of the drying devices is disposed in both sides of the casting surface and the rear surface, the thermal energy to be supplied for drying the casting film 69 is enough and adequate for the drying

In followings an method of producing the film 82 by the film production line 40 will be explained However the present invention is not restricted in this embodiment

The casting dope 27 is always made uniform by rotating a stirrer 61 To the casting dope 27 the additive (such as the plasticizer the UV absorbing agent and the like) may be mixed during the stirring The casting dope 27 is fed out to the filtration device 42 by the pump 62 and then cast from the casting die 43 onto the casting belt 46 The back-up rollers 44 45 is preferably driven such that the tension to the casting belt 46 may be controlled to a predetermined value in the range of 10⁴ N/m to 10⁵ N/m Further in this experiment the control was made such that the difference of the relative speed between the back-up rollers 44 45 was at most 0 01 m/min Further the control was made such that the variation of the speed of the casting belt 46 was at most 0 5% to the predetermined value The position of the casting belt 46 in the widthwise direction was controlled with detection of the position of the side end such that meandering of the casting belt 46 running for one circle was reduced in 1 5 mm Further below the casting die 43 the variation of the position in the vertical direction between the lip end of the casting die 43 and the casting belt 46 was in 200 μm The casting belt 46 is preferably incorporated in the casting chamber 39 which has air pressure controller (not shown) The casting dope was cast onto the casting belt 46 from the casting die 43 At the casting the temperature in the casting chamber 64 is preferably controlled in the range of −10° C. to 57° C. The solvent vapor in the casting chamber 64 is recovered by the recovering device 67 and reused as the solvent for preparing the dope

The casting dope 271s cast from the casting die 43 onto the casting belt 46 circulatory running so as to form the casting film 69 At the casting, the temperature of the casting dope 27 is preferably controlled in the range of −10° C. to 57° C. Further in order to stabilize the formation of a bead of the cast dopes the decompression chamber 68 is preferably provided for controlling the pressure in the back side of the bead Preferably the decompression is made such that the pressure of the upstream side may be 2000 Pa to 10 Pa lower than that of the downstream side It is preferable to provide the decompression chamber 68 with a Jacket (not shown) for controlling the inner temperature The temperature of the decompression chamber 68 is not restricted especially However the temperature is preferably at least the boiling point of the used organic solvent Further aspirators (not shown) may be provided with the decompression chamber 68 so as to be near both side edges of a dope outlet of the casting die 43 Thus the aspiration in both side edges of the bead is made to stabilize the shape of the bead In this case the force velocity of the aspiration is preferably in the range of one to one hundred Litter/min

The drying air is fed out from the first air duct 102 near the casting film 69 just after the formation thereof on the casting belt 46 while the temperature of the drying air is adjusted to the predetermined value in the predetermined range on the basis of the relation between the temperature of the casting belt 46 and the content of remaining solvent in the casting film 69 Simultaneously the heating of the drying belt 46 is made by the heating device 110 Thus the drying temperature is controlled Thereafter the drying of the casting film 69 is made by the second air duct 103 and the second heating device 111

The back-up roller 441s heated by the fourth heating device 113 disposed in the back-up roller 44 such that the thermal energy may be supplied to the casting film 69 Thereafter the drying of the casting film 69 is made by the third air duct 104 and the third heating device 111 During the drying in the casting chamber 64 the setting temperatures of the drying devices (namely the first-third air ducts 102-104 and the first-fourth heating devices 110-113) were controlled on the basis of the graph of the film production limit line

When the cast dope has self-supporting property the casting film 69 is continuously peeled as the film 82 with support of the peel roller 75 Thereafter in the transfer area 80 the film 82 is transferred with use of the pass rollers During the transference a drying air is fed from the air duct to dry the film 82 such that the drying may proceed Preferably the temperature of the drying air is in the range of 20° C. to 250° C. Note in the transfer area 80 that the rotating speed of the pass roller may be set to be higher in the downstream side so as to draw the film 82 Note that the peeling is preferably made at the content of remaining solvent in the range of 10 mass % to 200 mass % on the basis of solids

During the transportation in the tenter device 47 the film 82 is held by clipping both side edge portions and at the same time the drying is made to evaporate the solvent The tenter device 47 is preferably partitioned into several temperature areas of different temperatures such that the drying is made under different drying conditions of the respective temperature areas At the same time, the stretching of the film 82 in the widthwise direction may be made In this case in the transfer area 80 or/and the tenter device 47, the stretching in the widthwise direction and the drawing in the lengthwise direction are made such that the width and the length may be in the range of 0 5% to 300% larger than the original size

The film 82 is dried until the content of the remaining solvent become the predetermined value and fed out as the film 82 from the tenter device 47 toward the edge slitting device 50 for slitting off both side edge portions The slit side edge portions are sent to the crusher 90 by a cutter blower (not shown) and crushed to tips by the crusher 90 The tips are reused for preparing the dope which is effective in view of the decrease of the production cost Note that the slitting process of both side edge portions may be omitted However it is preferable to perform the slitting between the casting process and the winding process

The film 82 whose side edge portions are slit off is sent to the drying chamber 51 and dried furthermore In the drying chamber 51 the film 82 is transported with lapping on the rollers 91 The inner temperature of the drying chamber 51 is not restricted especially However it is preferable in the range of 50° C. to 160° C. The solvent vapor evaporated from the film 82 by the drying chamber 51 is adsorbed and recovered by the recovering device 92 The air from which the solvent components are removed is reused for the drying air in the drying chamber 51 Note that the drying chamber 51 preferably has the drying devices whose setting temperatures are respectively determined such that the casting film 69 may be dried at the different temperatures during the conveyance in the casting chamber 64 Further a pre-drying chamber (not shown) is provided between the edge slitting device 50 and the drying chamber 51 so as to perform the pre-drying of the film 82 Thus it is prevented that the temperature of the film 82 increases rapidly and therefore the change of the shape of the film 82 is reduced

The film 82 is transported into the cooling chamber 52 and cooled therein to around the room temperature A humidity control chamber (not shown) may be provided for conditioning the humidity between the drying chamber 51 and the cooling chamber 52 Preferably in the humidity control chamber an air whose temperature and humidity are controlled is applied to the film 82 Thus the curling of the film 82 and the winding defect in the winding process can be reduced

Thereafter a compulsory neutralization device (or a neutralization bar) 93 eliminates the charged electrostatic potential of the film 82 to the predetermined value (for example in the range of −3 kV to +3 kV) The position of the neutralization process is not restricted in this embodiment For example the position may be a predetermined position in the drying section or in the downstream side from the knurling roller 94 and otherwise the neutralization may be made at plural positions After the neutralization the embossing of both side portions of the film 82 is made by the embossing rollers to provide the knurling The emboss height from the bottom to the top of the embossment is in the range of 1 μm to 200 μm

In the last process, the film 82 is wound by a winding shaft 95 in the winding chamber 53 At this moment a tension is applied at predetermined values to a press roller 96 Preferably the tension is gradually changed from the start to the end of the winding In the present invention the length of the film 121 is preferably at least loom The width of the film is preferably at least 600 mm and particularly in the range of 1400 mm to 1800 mm Further even if the width is more than 1800 mm the present invention is effective The film thickness can be applied when it is designated to form a thin film of 30 μm to 300 μm in thickness

In the solution casting method of the present invention there are casting methods for casting plural dopes, for example a co-casting method and a sequential casting method In the co-casting method the feed block may be attached to the casting die 91 as in this embodiment or a multi-manifold type casting die (not shown) may be used In the film of multi-layer structure at least one of the thickness of the peeled layer (lowermost layer) from the support and that of the opposite layer (uppermost layer) thereto is preferably in the range of 0 5% to 30% of the total film thickness Furthermore when it is designated to perform the co-casting, a dope of higher viscosity is sandwiched by lower-viscosity dopes Concretely it is preferable that the dopes for forming the surface layers (namely lower- and uppermost layers) have lower viscosity than the dope for forming a layer (intermittent layer) sandwiched by the surface layers Further when the co-casting is designated it is preferable in the bead between die slit and the support that the composition of alcohol is higher in the two outer dopes than the inner dope

Japanese Patent Laid-Open Publication No 2005-104148 describes from [0617] to [0889] in detail about the structures of the casting die the decompression chamber the support and the like and further about the co-casting the peeling the stretching the drying conditions in each process the handling method the curling the winding method after the correction of planarity the solvent recovering method the film recovering method The descriptions thereof can be applied to the present invention

[Properties & Measuring Method]

(Degree of Curl & Thickness)

Japanese Patent Laid-Open Publication No 2005-104148 describes from [1073] to [1087] about the measuring method of the wound cellulose acylate film The measuring methods can be applied to the present invention

[Surface Treatment]

The cellulose acylate film is preferably used in several ways after the surface treatment of at least one surface The preferable surface treatments are vacuum glow discharge plasma discharge under the atmospheric pressure UV-light irradiation corona discharge flame treatment acid treatment and alkali treatment Further it is preferable to make one of these sorts of the surface treatments

[Functional Layer]

(Antistatic Curing Antireflection Easily Adhesive & Antiglare Layers)

The film 82 may be provided with an undercoating layer on at least one of the surfaces and used in the several ways

The obtained cellulose acylate film is used as a base film on which functional layers are formed Thus several sorts of functional materials are obtained The functional layers is at least one of antistatic layer curable resin layer antireflection layer easy adhesive layer antiglare layer and optical compensation layer

These functional layers preferably contain at least one sort of surfactants in the range of 0 1 mg/m² to 1000 mg/m² Further the functional layers preferably contain at least one sort of lubricants in the range of 0 1 mg/m² to 1000 mg/m² The functional layers preferably contain at least one sort of matting agents in the range of 0 1 mg/m² to 1000 mg/m² The functional layers preferably contain at least one sort of antistatic agents in the range of 1 mg/m² to 1000 mg/m² The method for forming the surface treatment functional layer are described in other publications than the above one, such as from [0890] to [1072] in the Japanese Patent Laid-Open Publication No 2005-104148

described in other publication than

(Variety of Use)

The produced cellulose acylate film can be effectively used as a protection film for a polarizing filter In the polarizing filter the cellulose acylate film is adhered to a polarizer Usually two polarizing filters are adhered to a liquid crystal layer such that the liquid crystal display may be produced Note that the arrangement of the liquid crystal layer and the polarizing filters are not restricted in it and several arrangements already known are possible Japanese Patent Laid-Open Publication No 2005-104148 discloses the liquid crystal displays of TN type STN type VA type OCB type reflective type and other types in detail The description may be applied to the present invention Further in this publication No 2005-104148 describes a cellulose acylate film provided with an optical anisotropic layer and that having antireflection and antiglare functions Further the produced film can be used as an optical compensation film since being double axial cellulose acylate film provided with adequate optical properties Further the optical compensation film can be used as a protective film for a polarizing filter The detail description thereof is made from [1088] to [1265] in the publication No 2005-104148

In the method of forming the polymer film of the present invention the formed cellulose acylate film is excellent in optical properties The TAC film can be used as the protective film for the polarizing filter a base film of the photosensitive material and the like Further in order to improve the view angular dependence of the liquid crystal display (used for the television and the like) the produced film can be also used for the optical compensation film Especially the produced film is effectively used when it doubles as protective film for the polarizing filter Therefore the film is not only used in the TN-mode as prior mode but also IPS-mode OCB-mode VA-mode and the like Further the polarizing filter may be constructed so as to have the protective film as construction element

In followings Examples of the present invention will be explained However the present invention is not restricted in it

### Example 1

(Composition)

| | | |
|---|---|---|
| Cellulose Triacetate | 100 | pts mass |
| (Powder degree of substitution 2 84 viscosity- | | |
| average degree of polymerization 306 water content | | |
| 0 2 mass % viscosity of 6 mass % dichloromethane | | |
| solution 315 mPa s averaged particle diameter 1 5 mm | | |
| standard deviation of particle diameter 0 5 mm) | | |
| Dichloromethane (first solvent compound) | 320 | pts mass |
| Methanol (second solvent compound) | 83 | pts mass |
| 1-butanol (third solvent compound) | 3 | pts mass |
| Plasticizer A (triphenylphosphate) | 7 6 | pts mass |
| Plasticizer B (diphenylphosphate) | 3 8 | pts mass |
| UV-absorbing agent A | 0 7 | pts mass |
| (2(2-hydroxy-3 5-di-tert-butylphenyl)benzotnazol) | | |
| UV-absorbing agent B | 0 3 | pts mass |
| (2(2-hydroxy-3 5-di-tert-amylphenyl)-5- | | |
| chlorobenzotriazol) | | |
| Mixture of citric acid esters | 0 006 | pts mass |
| (Mixture of citric acid citric acid monoethyl ester | | |
| citric acid dimethyl ester citric acid triethyl | | |
| ester) | | |
| Particles | 0 05 | pts mass |
| (silicon dioxide particle diameter 15 nm Mohs | | |
| Hardness about 7) | | |

[Cellulosetriacetate]

According to cellulose triacetate used an this experiment the remaining content of acetic acid was at most 0 1 mass % the Ca content was 58 ppm the Mg content was 42 ppm the Fe content was 0 5 ppm the free acetic acid was 40 ppm and the sulfuric ion content was 15 ppm The degree of acetylation at 6^{th} position was 0 91 and the percentage of acetyl groups at 6^{th} position to the total acetyl groups was 32 5% The acetone extract was 8 mass % and a ratio of weight-average molecular weight to number-average molecular weight was 2 5 Further yellow index was 1 7 haze was 0 08 and transparency was 93 5% Tg (measured by DSC) was 160° C. and calorific value in crystallization was 6 4 J/g This cellulose triacetate is synthesized from cellulose as material obtained from cotton and called cotton TAC in the following explanation

The casting dope 27 was prepared in the dope production line 10 of FIG. 2 The mixing tank 12 had first and second stirrers 22 24 and was made of stainless and 4000 L in volume Into the mixing tank 12 plural solvent compounds were mixed such that a mixture solvent was obtained Note that the water content in each solvent compound is at most 0 5 mass % The stirring was made with use of the first stirrer 22 having the anchor blade and the second stirrer 24 which was eccentric stirrer of dissolver type At first the first stirrer 22 performed the stirring at one m/sec as circumferential velocity and the second stirrer 24 performed the stirring at shear rate at first 5 m/sec Thus the dispersion was made for 30 minutes during the stirring The dissolving started at 25° C. and the temperature of the dispersion became 48° C. at last

While the stirring of the mixture solvent was made the cellulose triacetate flakes were added from the hopper 14 to the mixture solvent gradually such that the total mass of the mixture solution and the cellulose triacetate flakes might be 2000 kg After the dispersion the high speed stirring (of the second stirrer 24) was stopped and the stirring was performed by the first stirrer 22 at 0 5 m/sec as circumferential velocity for 100 minutes Thus cellulose triacetate flakes was swollen such that the mixture liquid 25 was obtained Until the end of the swelling the inner pressure of the mixing tank 12 was increased to 0 12 MPa with use of nitrogen gas At this moment the hydrogen concentration in the mixing tank 12 was less than 2 vol % which does not cause the explosion Further water content in the dope was 0 3 mass %

The mixture liquid 25 was fed to the heating device which is the tube with the Jacket and heated to 50° C. and thereafter heated under the application of pressure at 2 MPa to 90° C. Thus the dissolving was made completely The heating time was 15 minutes The temperature of the mixture liquid 25 is decreased to 36° C. by the temperature controller 16 and then filtrated through the filtration device having filtration material whose nominal diameter was 8 μm At this moment the upstream side filtration pressure was 1 5 MPa and the downstream side filtration pressure was 1 2 MPa Since the filter the housing and the pipes were made of hastelloy alloy and had Jacket for using at high temperature they were made from materials excellent in corrosion resistance

The dope was fed into the flushing device whose pressure was kept to the atmospheric pressure at 80° C., such that the flush evaporation of the dope was made The solvent vapor was condensed by the condenser to the liquid state and recovered by the recovering device 32 After the flushing the content of solid compounds in the dope was 21 8 mass % Note that the recovered solvent was recycled by the refining device 33 and reused The anchor blade is provided at a center shaft of a flush tank of the flushing device 30 and the dope was stirred by the anchor blade at 0 5 m/sec as circumferential velocity The temperature of the dope in the flush tank was 25° C. the retaining period of the dope in the flush tank was 50 minutes Part of the dope was sampled and the measurement of the shearing viscosity was made at 25° C. The shearing viscosity was 450 Pa s at 10 (l/s) of shearing rate

Then the defoaming was further made by irradiating very weak ultrasonic waves Thereafter the dope was fed to the filtration device by the pump under the application of pressure at 1 5 MPa In the filtration device the dope was fed at first through a sintered fiber metal filter whose nominal diameter was 10 μm and then through the same filter of 10 μm nominal diameter At the forward and latter filters the upstream pressures were respectively 1 5 MPa and 1 2 MPa and the downstream pressures were respectively 1 0 MPa and 0 8 MPa The temperature of the dope after the filtration was controlled to 36° C. and stored as the casting dope 27 in the stainless stock tank 41 whose volume was 2000 L The anchor blade is provided to a center shaft of the stock tank 41 and the casting dope 27 was always stirred by the first stirrer 22 of the anchor blade at 0 3 m/sec as circumferential velocity

The film is formed in the film production line 40 shown in FIG. 2 The pump for increasing the upstream pressures was high accuracy gear pumps and driven to feed the casting dope 27 while the feed back control was made by an inverter motor Thus the upstream pressure of high accuracy gear pump was controlled to 0 8 MPa As for the pump volumetric efficiency was 99 2% and the variation rate of the discharging was at most 0 5% Further the discharging pressure was 1 5 MPa

The width of the casting die 43 was 1 8 m The flow rate of the casting dope 27 near a die lip of the casting die 43 is controlled such that the dried film may be 80 μm in thickness The casting width of the casting dope 27 from the die lip was 1700 mm Further in order to control the temperature of the casting dope 27 to 36° C. the casting die 43 was provided with a Jacket (not shown) the temperature of the heat transfer medium to be supplied in the Jacket was 36° C. at an entrance of the Jacket

The temperature of the casting die 43 and pipes was kept to 36° C. in the film production The casting die 43 was the coat hunger type in which heat bolts for adjusting the film thickness were disposed at the pitch of 20 mm Thus the film thickness (or the thickness of the dopes) is automatically controlled by the heat bolt A profile of the heat volt can be set corresponding to the flow rate of the high accuracy gear pump on the basis of the preset program Thus the feed back control can be made by the control program on the basis of the profile of an infrared ray thickness meter (not shown) disposed in the film production line 40 The control was made such that with exception of both side edge portions (20 mm each in the widthwise direction of the produced film) the difference of the film thickness between two positions which were 50 mm far from each other might be at most 1 μm and the largest difference between the minimal values of the film thickness in the widthwise direction might be at most 3 μm/m Further the average film thickness might was controlled in ±1 5%

The upstream side of the casting die 43 is provided with the decompression chamber 68 The decompression rate of the decompression chamber 68 was controlled in accordance with the casting speed such that the pressure difference might occur in the range of one Pa to 5000 Pa between the upstream and downstream sides of the bead of the cast dope above the casting die At this time the pressure difference between both side of a bead of the cast dope was determined such that the length of the bead might be from 20 mm to 50 mm Further an instrument was provided such that the temperature of the decompression chamber 68 might be set to be higher than the condensation temperature of the gas around the casting section Further there were labyrinth packings (not shown) in the upstream and downstream sides of the beads Further an opening was provided in both edges of the die lip of the casting die 43 Further an edge suctioning device (not shown) for reducing the disturbance of the bead was provided for the casting die 43

The material of the casting die 43 was the precipitation hardening stainless steel whose coefficient of thermal expansion was at most 2×10⁻⁵ (° C.¹) The finish accuracy of the contact surface of each casting die to the casting dope 27 was at most 1 μm in surface roughness straightness in any direction was at most 1 μm in surface roughness and the slit clearance of the die lip was adjusted to 1 5 mm On the die lip of the lip end of the casting die 43 the tungsten carbide coating can be made by a spraying method so as to form the hardened layer According to an edge of the contact portion of a lip end of the casting die 43, R is at most 50 μm in all of a width

In order to prevent the dry and solidification on part of the slit end of the casting die 43 the mixture solvent A dissolvable of the solidified dope was prepared by mixing dichloromethane 86 5 pts mass acetone 13 pst mass and 1-butanol 0 5 pts mass The mixture solvent A was supplied to each edge portion of the gas-liquid interface of the slit at 0 5 ml/min Thus the mixture solvent is supplied to each bead edge The pulse rate of a pump for supplying the mixture solvent was at most 5% Further the decompression chamber 68 was provided for decreasing the pressure in the rear side by 150 Pa In order to control the temperature of the decompression chamber 68 a jacket (not shown) was provided and a heat transfer medium whose temperature was controlled at 35° C. was supplied into the Jacket The edge suction rate could be controlled in the range of 1 L/min to 100 L/min and was adequately controlled in this experiment so as to be in the range of 30 L/min to 40 L/min

In the casting chamber 64 in which an air pressure controller (not shown) is provided the casting dope 27 is cast from the casting die 43 onto the casting belt 46 The casting belt 46 was a SUS316endless stainless belt which was 2 μm in width and 70 m in length The thickness of the casting belt 46 was 1 5 mm and the surface of the casting belt 46 was polished such that the surface roughness might be at most 0 05 μm The thickness nonuniformity of the entire casting belt 46 was at most 0 5% of the predetermined value The casting belt 46 was moved by rotating the back-up rollers 44 45 At this moment the tension of the casting belt 46 was controlled to 1 5×10⁵ kg/m Further the relative speed to each roller to the casting belt 46 changed However in this experiment the control was made such that the difference of the relative speed between the back-up rollers 44 45 was at most 0 01 m/mm Further the control was made such that the variation of the speed of the casting belt 46 was at most 0 5% to the predetermined value The position of the belt in the widthwise direction was controlled with detection of the position of the side end such that meandering in one circle of the moving casting belt 46 was reduced in 1 5 mm Further below the casting die 72 the variation of the position in the vertical direction between the lip end of the casting die and the casting belt 46 was in 200 μm.

In this experiment the back-up rollers 44 45 were supplied therein with a heat transfer medium such that the temperature of the casting belt 46 might be controlled The back-up roller 45 disposed in a side of the casting die 72 was supplied with the heat transfer medium at 5° C., and the back-up roller 44 was supplied with the heat transfer medium at 40° C. The surface temperature of the middle portion of the casting belt 46 at a position just before the casting was 15° C. and the temperature difference between both sides of the casting belt 46 was at most 6° C. Note that a number of pinhole (diameter at most 30 μm) was zero a number of pinhole (diameter 10 μm to 30 μm) was at most one in square meter and a number of pinhole (diameter less than 10 μm) was at most two in square meter

The temperature of the casting chamber 64 was kept to 35° C. At first the drying air was fed out in parallel to the casting film 69 so as to make the drying. The overall heat transfer coefficient from the drying air to the casting film 69 was 24 kcal/(m² hr ° C.)

As shown in FIG. 3 the first-third air ducts 102-104 were disposed as the drying devices so as to confront to the casting surface and the first-third heating devices 110-112 were disposed as the drying devices so as to confront to the rear surface The first-third air ducts 102-104 were positioned sequentially from the up-to the downstream The air outlet of each of first-third air ducts 102-104 is directed so as to feed the drying air in the running direction of the casting belt 46 Further, the first heating device 110 was positioned oppositely to the first air duct 102, the second heating device 111 was positioned oppositely to the second air duct 103 and the third heating device 112 was positioned oppositely to the third air duct 104 Further the fourth heating device 113 was disposed in the back-up roller 44 so as to heat the casting belt 46 from the rear surface on the back-up roller 44

From the formula (I) the drying temperatures were previously determined in accordance with the content of remaining solvent in the casting film 69 Then the drying temperature in each drying zone is controlled by adjusting the setting temperature of each air duct for feeding the drying air and the setting temperature of each heating devices such that the drying of the casting film 69 might be made at the predetermined drying temperature Concretely the setting temperatures were 140° C. at the first air duct 102 140° C. at the second air duct 103 70° C. at the third air duct 104 20° C. at the first heating device 110 30° C. at the second heating device 111 50° C. at the third heating device 112 and 40° C. at the fourth heating device 113

In order to keep the oxygen concentration to 5 vol % the inner air of the drying atmosphere was substituted by nitrogen gas The solvent vapor in the casting chamber 64 was recovered by setting the temperature of exit of the condenser 98 to −10° C.

When the content of remaining solvent becomes lower to 50 wt % the film 82 was peeled from the casting belt 46 with use of the peel roller 75 Further the peeling tension was 1×10² N/m² In order to reduce the peeling defects the percentage of the peeling speed (the draw of the peel roller) to the speed of the casting belt 46 was controlled from 100 1% to 110% The surface temperature of the film 82 was 15° C. The drying speed on the casting belt 46 was 60 mass %/min in average on dry basis The solvent vapor generated in the evaporation is condensed by the condenser 98 at −10° C. to a liquid state and recovered by the recovering device 67 The water content of the recovered solvent was adjusted to at most 0 5% Further the air from which the solvent components were removed was heated again and reused for the drying air The film 82 was transported with the rollers in the transfer area 80 toward the tenter device 47 In the transfer area 80 it is to be noted that the drying air was applied so as to dry the film 82 while the tension about 30N was applied to the film 82 in the lengthwise direction of the rollers The temperature of the drying air from the air blower 81 was 40° C.

According to the stretching ratio in the tenter device 47 the difference of the actual stretching ratio was at most 10% between positions which were at least 10 mm apart from the holding positions of the clips and at most 5% between positions which were 20 mm apart from the holding portions In the side edge portions in the tenter device 47 the ratio of the length variation between the clip starting position and the clip releasing position was made was 90% The solvent vapor generated in the tenter device 47 was condensed at −10° C. to a liquid state and recovered For the condensation a condenser (not shown) was provided and a temperature at an exit thereof was −8° C. The water content in the recovered solvent was regulated to at most 0 5 mass % and then the recovered solvent was reused The film 82 was fed out as the film 82 from the tenter device 47

In 30 seconds from exit of the tenter device 47 both side edge portions were slit off in the edge slitting device 50 In this experiment each side portion of 50 mm in the widthwise direction of the film 82 was determined as the side edge portion which were slit off by an NT type slitter of the edge slitting device 50 The slit side edge portions were sent to the crusher 90 by applying air blow from a blower (not shown), and crushed to tips about 80 mm² The tips were reused as raw material with the TAC frame for the dope production The oxygen concentration in the drying atmosphere in the tenter device 47 was kept to vol % Note that the air was substituted by nitrogen gas in order to keep the oxygen concentration at 5 vol % Before the drying at the high temperature in the drying chamber 51 the pre-heating of the film 82 was made in a pre-heating chamber (not shown) in which the air blow at 100° C. was supplied

The film 82 was dried at high temperature in the drying chamber 51 which has four temperature areas Air blows whose temperatures were 120° C. 130° C. 130° C. and 130° C. from the upstream side were fed from air ducts (not shown) to the partitions The transporting tension of each roller 91 to the film 82 was 100 N/m The drying was made for ten minutes such that the content of the remaining solvent might be 0 3 mass % The lapping angle (center angle of contacting arc) of the roller 4 was 90° and 180° The rollers 91 were made of aluminum or carbon steel On the surface the hard chrome coating was made The surfaces of the rollers 91 were flat or processed by blast of matting process The swing of the roller in the rotation was in 50 μm

The solvent vapor contained in the drying air is removed with use of the recovering device 92 in which an adsorbing agent was used The adsorbing agent was active carbon and the desorption was performed with use of dried nitrogen The recovered solvent was reuse as the solvent for the dope preparation after the water content might be at most 0 3 mass % The drying air contains not only the solvent vapor but also gasses of the plasticizer UV-absorbing agent and materials of high boiling points Therefore a cooler for removing by cooling and a preadsorber were used to remove them Thus the drying air was reused The ad- and desorption condition was set such that a content of VOC (volatile organic compound) in exhaust gas might be at most 10 ppm Furthermore in the entire solvent vapor the solvent content to be recovered by condensation method was 90 mass % and almost of the remaining solvent vapor was recovered by the adsorption recovering

The film 82 was transported to a first moisture controlling chamber (not shown) In a transport area between the drying chamber 51 and the first moisture controlling chamber the drying air at 110° C. was fed In the first moisture controlling chamber the air whose temperature was 50° C. and dewing point was 20° C. was fed Further the film 82 was fed into a second moisture chamber (not shown) in which the curling of the film 82 was reduced An air whose temperature was 90° C. and humidity was 70% was applied to the film 82 in the second moisture controlling chamber

After the moisture adjustment the film 82 was cooled to 30° C. in the cooling chamber 107 and then the edge slitting was performed The compulsory neutralization device (or a neutralization bar) 93 was provided such that in the transportation the charged electrostatic potential of the film might be in the range of −3 kV to +3 kV Further the film knurling was made on a surface of each side of the film 82 by the knurling roller 94 The width of the knurling was 10 mm and the knurling pressure was set such that the maximal thickness might be at most 12 μm larger in average than the averaged thickness

The film 82 was transported to the winding chamber 53 whose inside temperature and humidity were respectively kept to 28° C. and 70% Further a compulsory neutralization device (not shown) was provided such that the charged electrostatic potential of the film might be in the range of −1 5 kV to +1 5 kV The obtained film 82 was 80 μm in thick and 1475 mm in width The diameter of the winding shaft 95 was 169 mm The tension pattern was set such that the winding tension was 300 N/width at first and 200 N/m at last The film 82 was entirely 3940 m in length The winding cycle was 400 m and the meandering was in ±5 mm Further the pressure of the press roller 96 to the winding shaft 95 was set to 50 N/m The temperature of the film at the winding was 25° C. the water content was 1 4 mass % and the content of the remaining solvent was 0 3 mass %

### Example 2

The film 82 was produced from the same casting dope 27 by the same production method as Example 1 However when the casting film 69 formed on the casting belt 46 is dried the drying temperatures were determined without consideration of the graph of the film production limit line The setting temperatures were 160° C. at the first air duct 102 160° C. at the second air duct 103 70° C. at the third air duct 104 30° C. at the first heating device 110 40° C. at the second heating device 111 50° C. at the third heating device 112 and 50° C. at the fourth heating device 113 Thus the drying of the casting film 69 was made

In each of the Examples 1 & 2 the surface of the casting film 69 was observed near an exit of the casting chamber 64 and it was estimated whether the foaming and the curling occurred As the result the foaming and the curling were not observed in Example 1 However the foaming occurred so much and the curling occurred partially

In Example 1 the produced film didn t have the forming and the curling and was excellent in the planarity which was different from Example 2 The reason for the difference between Examples 1 and 2 was the difference of determining the drying temperatures for drying the casting film 69 Namely in Example 1 since the main solvent was dichlorimethane the drying temperature was previously determined according to the content of remaining solvent in the casting film 69 in reference with the graph of the film production limit line g_{dm} of FIG. 3 and then the drying of the casting film 69 was made However in Example 2 the drying temperatures were determined experimentally and the drying of the casting film 69 was made

In order to dry the casting film without occurrence of the foaming and the curling several drying devices are provided so as to confront to the casting surface and the rear surface of the casting belt and the setting temperature of each drying device is independently determined Thus the solvent in the casting film is gradually evaporated in the drying which reduces the foaming and the curling Further the setting temperature of each drying device is determined according to the content of remaining solvent in the casting film in reference with the graph of the film production limit line that is different between the sorts of the main solvent compounds

Thus the drying temperatures in the drying zones are previously determined adequately to the content of remaining solvent Therefore the drying of the casting film can be made without a large luck of supply with the thermal energy and the like

1. A producing method of a polymer film comprising steps of:
casting onto a casting surface of a endlessly running support a dope containing a polymer and a solvent, so as to form a casting film;
feeding out an drying air from an outlet of an air feeding device confronting to said casting surface, said outlet being directed in a running direction of said support;
heating said support by a heating device confronting to a rear surface of said support;
determining setting temperatures of said air feeding device and said heating device according to a content of remaining solvent in said casting film at starting the drying by said air feeding device and said heating device, in reference with a relation between a temperature of said support and said content of remaining solvent;
peeling said casting film as a polymer film from said support; and
drying said polymer film.

2. A producing method described in claim 1, wherein said setting temperature of said heating device is almost constant in the range of 40° C. to 100° C.

3. A producing method described in claim 2, wherein said air feeding device and said heating device are respectively plural, and said setting temperature of each of said air feeding devices and said heating devices is adjusted independently.

4. A producing method described in claim 1,
wherein a main solvent compound of said solvent is dichloromethane, and
wherein when a content of remaining dichloromethane in said casting film is W (mass %), the setting temperature of said air feeding device and said heating device is set such that the temperature T (° C.) of said support may satisfy a condition (I):
T≦4.5×10⁻⁴×W²−0.25×W+61. (I)

5. A producing method described in claim 1,
wherein a main solvent compound of said solvent is methyl acetate, and
wherein when a content of remaining methyl acetate in said casting film is W (mass %), the setting temperature of said air feeding device and said heating device is set such that the temperature T (° C.) of said support may satisfy a condition (II):
T≦6.6×10⁻⁴×W²−0.4×W+87 (II)

6. A producing method described in claim 1, wherein the peeling of said casting film is performed when said content of remaining solvent decreases to at most a predetermine value.
